(19) United States
(12) Patent Application Publication
(10) Pub. No.: US 2026/0347105 A1
(43) Pub. Date: Nov. 5, 2026

(54) BIN ARRANGEMENT CONTROL METHOD AND BIN ARRANGEMENT CONTROL DEVICE

(71) Applicant: Panasonic Intellectual Property Management Co., Ltd., Osaka (JP)

(72) Inventors: Yoshinari MATSUYAMA, Osaka (JP); Takeshi SHIMAMOTO, Hyogo (JP)

(73) Assignee: Panasonic Intellectual Property Management Co., Ltd., Osaka (JP)

(21) Appl. No.: 19/486,608

(22) PCT Filed: Mar. 28, 2024
(86) PCT No.: PCT/JP2024/012555

§ 371 Date: Nov. 21, 2025

(30) Foreign Application Priority Data
May 31, 2023 (JP) 2023-090465

(51) Int. Cl. B65G 1/04; G06Q 10/087

(52) U.S. Cl. CPC B65G 1/0485; G06Q 10/08724

(57) ABSTRACT

A bin arrangement control method for controlling arrangement of a bin with respect to a picking robot that performs a picking work of an object, in which the bin includes a storage bin in which the object before the picking work is stored and a delivery bin in which the object after the picking work is stored, and the bin arrangement control method includes the steps of: acquiring object information on the object; determining a positional relationship between the storage bin and the delivery bin based on the object information; and controlling arrangement of the storage bin and the delivery bin with respect to the picking robot, based on the determined positional relationship.

### TECHNICAL FIELD

The present disclosure relates to a bin arrangement control method and a bin arrangement control device.

### BACKGROUND ART

Conventionally, an information processing method of assigning a picking process to a picking means is known (see Patent Literature 1). The information processing method of Patent Literature 1 generates a picking work list of picking work of picking an article from a shelf conveyed by an automatic conveyance vehicle on the basis of an order list acquired from an external device, calculates a processing capability of processing the picking work included in the picking work list for each picking means on the basis of a work log related to past picking work, and assigns the picking work included in the generated picking work list for each picking means on the basis of the processing capability. The picking means is a worker or a robot.

### CITATION LIST

### Patent Literature

PTL 1: Unexamined Japanese Patent Publication No. 2023-017393

### SUMMARY OF THE INVENTION

The present disclosure provides a bin arrangement control method and a bin arrangement control device capable of shortening a time required for picking work when performing the picking work of moving an object from a storage bin to a delivery bin using a picking robot.

An aspect of the present disclosure is a bin arrangement control method for controlling arrangement of a bin with respect to a picking robot that performs picking work of an object, the bin including a storage bin in which the object before the picking work is stored and a delivery bin in which the object after the picking work is stored, the bin arrangement control method including the steps of: acquiring object information on the object; determining a positional relationship between the storage bin and the delivery bin based on the object information; and controlling arrangement of the storage bin and the delivery bin with respect to the picking robot, based on the determined positional relationship.

An aspect of the present disclosure is a bin arrangement control device that includes a processor and controls arrangement of a bin with respect to a picking robot that performs picking work of an object, in which the bin includes a storage bin in which the object before the picking work is stored and a delivery bin in which the object after the picking work is stored, and the processor acquires object information on the object, determines a positional relationship between the storage bin and the delivery bin based on the object information, and controls arrangement of the storage bin and the delivery bin with respect to the picking robot based on the determined positional relationship.

According to the present disclosure, it is possible to shorten the time required for the picking work when performing the picking work of moving the object from the storage bin to the delivery bin using the picking robot.

### BRIEF DESCRIPTION OF THE DRAWINGS

FIG. 1 is a schematic diagram illustrating an appearance example of a warehouse management system according to a first exemplary embodiment.

FIG. 2 is a diagram illustrating an example of an environment in a warehouse.

FIG. 3 is a diagram illustrating an example of a picking station in which a worker is disposed.

FIG. 4 is a diagram illustrating an example of a picking station in which a picking robot that is an orthogonal robot is disposed.

FIG. 5 is a diagram illustrating an example of a picking station in which a picking robot that is an articulated robot is disposed.

FIG. 6 is a diagram illustrating a configuration example of a bin.

FIG. 7 is a diagram illustrating an example of a bin and a conveyance robot that conveys the bin.

FIG. 8 is a diagram illustrating an arrangement image of a camera.

FIG. 9 is a block diagram illustrating a configuration example of a host management device.

FIG. 10 is a block diagram illustrating a configuration example of a robot control system.

FIG. 11 is a diagram illustrating an example of picking instruction data.

FIG. 12 is a diagram illustrating an example of robot configuration information.

FIG. 13 is a diagram illustrating an example of object information.

FIG. 14 is a diagram illustrating an example of picking success rate information.

FIG. 15 is a diagram illustrating an example of takt time information.

FIG. 16 is a diagram illustrating an example of picking result data.

FIG. 17 is a diagram illustrating an example of storage bin coordinates and delivery bin coordinates.

FIG. 18 is a flowchart illustrating an operation example of the host management device.

FIG. 19 is a flowchart illustrating an example of details of sorting processing.

FIG. 20 is a diagram illustrating an example of movement of bins at the time of picking work.

FIG. 21 is a block diagram illustrating a configuration example of a host management device according to a second exemplary embodiment.

FIG. 22 is a block diagram illustrating a configuration example of a robot control system according to the second exemplary embodiment.

FIG. 23 is a diagram illustrating updated picking instruction data I1A.

FIG. 24 is a diagram illustrating an image of a movement time of a hand in the XY directions according to the arrangement relationship between the storage bin and the delivery bin.

FIG. 25 is a view illustrating an image of a moving speed of the hand in the Z direction.

FIG. 26 is a diagram illustrating an image of movement of an object according to weight.

FIG. 27 is a flowchart illustrating an operation example of the host management device.

FIG. 28 is a view of the inside of the delivery bin and the storage bin as viewed from above.

FIG. 29 is a diagram illustrating an example of an arrangement pattern in which a storage bin and a delivery bin are arranged in a bin arrangement region.

FIG. 30 is a diagram illustrating an example of a flow of movement of a hand and an object at the time of picking.

### DESCRIPTION OF EMBODIMENT

Hereinafter, exemplary embodiments will be described in detail appropriately with reference to the drawings. However, unnecessarily detailed description may be omitted. For example, a detailed description of a well-known matter and a repeated description of substantially the same configuration may be omitted. This is to avoid an unnecessarily redundant description below and to facilitate understanding of a person skilled in the art. Note that the accompanying drawings and the following description are provided for those skilled in the art to fully understand the present disclosure, and are not intended to limit the subject matter described in the claims.

### Background to Obtain a First Exemplary Embodiment

In the information processing method of Patent Literature 1, although the picking means picks an article from a shelf and puts the article into a tray, it is not assumed that the product is picked from a storage bin in which the product is stored and stored in a delivery bin from which the product is delivered. In addition, although a picking robot is assumed as the picking means, it is not intended that there are a plurality of picking robots. For this reason, for example, in a case where each picking robot has good and bad at picking for each characteristic of the product, it is not considered which picking robot among the plurality of picking robots the storage bin is moved to the vicinity of.

In the following exemplary embodiment, a bin sorting method and a bin sorting device capable of improving the efficiency of picking work when picking work of moving an article from a storage bin to a delivery bin is performed using a plurality of picking robots will be described.

### First Exemplary Embodiment

### Configuration of Warehouse Management System

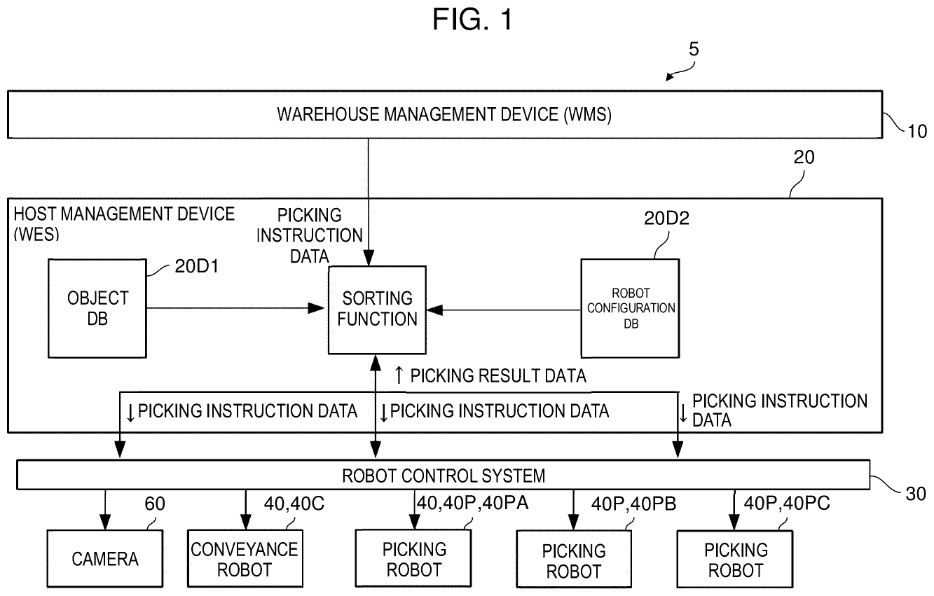

FIG. 1 is a diagram illustrating a configuration example of warehouse management system 5 according to a first exemplary embodiment. Warehouse management system 5 includes warehouse management device 10, host management device 20, robot control system 30, robot device 40, and camera 60. Robot device 40 includes conveyance robot 40C and picking robot 40P.

Warehouse management device 10 is a device for facilitating distribution in a warehouse, and is also called a warehouse management system (WMS). Warehouse management device 10 manages articles such as inventory. Warehouse management device 10 has an inventory management function and a warehousing/delivery management function. In the inventory management function, the warehouse management device 10 manages information regarding the state of the inventory currently stored. The information regarding the state of the inventory includes, for example, a storage position, an arrival date, a quantity, a consumption deadline, a color, a size, and the like of the article. In the warehousing/delivery management function, warehouse management device 10 manages a record of warehousing/delivery of an article. Warehouse management device 10 can manage the warehousing/delivery schedule and record the actual warehousing/delivery. Warehouse management device 10 also has a function of facilitating work associated with warehousing and delivery, such as creation of a picking list, a slip, and the like of articles.

Host management device 20 operates as a warehouse execution system (WES) and has functions of warehouse management and warehouse control. Host management device 20 is present between warehouse management device 10 and robot control system 30. In addition, host management device 20 can grasp work data of the site such as inventory management, warehousing, or picking of the article in real time. That is, host management device 20 is a device for comprehensively controlling a person, an article, a facility, and the like in the warehouse.

Host management device 20 has a work management function and a facility control function. In the work management function, host management device 20 makes the work situation of robot device 40 or the worker visible, and realizes progress recognition in real time. In addition, a predetermined instruction can be transmitted to a terminal (for example, wearable terminals and audio terminals) possessed by the worker or a terminal (for example, a display) installed in the work region. In addition, host management device 20 can control various devices (for example, robot device 40 or camera 60) in the warehouse in the control function of the facility.

Note that warehouse management device 10 and host management device 20 may be integrated, and one may have the other function.

Robot control system 30 operates as a warehouse control system (WCS). Robot control system 30 controls various devices (for example, robot device 40 or camera 60) in the warehouse in real time, thereby enabling warehousing and delivery on an optimal schedule. Robot control system 30 can monitor the operation of the device in real time and transmit predetermined instruction information to the device.

Robot device 40 contributes to automation of various work in the warehouse. Robot device 40 includes a plurality of conveyance robots 40C and a plurality of picking robots 40P.

Conveyance robot 40C conveys bin 70 in which various articles managed in the warehouse are stored. Bins 70 include storage bins 71 in which the warehoused articles are stored and delivery bins 72 in which the articles to be delivered are stored. Note that bin 70 may be an automated guided vehicle (AGV), and bin 70 itself may operate as conveyance robot 40C, that is, bin 70 may be self-propelled.

In response to an instruction from robot control system 30, picking robot 40P picks various articles stored in storage bin 71, and moves and stores the articles in delivery bin 72. Picking robot 40P includes an arm and a hand. The arm is accessible to a predetermined position inside bin 70. The articles in bin 70 can be picked. The hand is attached to the distal end of the arm. Picking robot 40P may include a plurality of picking robots 40PA, 40PB, and 40PC of different types.

Picking robot 40PA is an orthogonal suction robot. The orthogonal suction robot can move the arm in, for example, two orthogonal directions (for example, an X direction and a Y direction) along a horizontal plane and one direction (a Z direction) perpendicular to the horizontal plane, and sucks and picks an article by the hand. Picking robot 40PA can recognize, by robot control system 30, the surface of the article based on the captured image captured by camera 60. Picking robot 40PA is good at picking a box-shaped article, for example. Being good at picking here means, for example, that the picking success rate described later is high or the takt time is short.

Picking robot 40PB is an orthogonal two-finger robot. The orthogonal two-finger robot can move the robot arm in the X direction, the Y direction, and the Z direction described above, and pick an article using two fingers of the hand. Picking robot 40PB can recognize the shape of the article based on the image captured by camera 60 by robot control system 30. Picking robot 40P is good at picking a heavy article, for example.

Picking robot 40PC is an articulated robot. The articulated robot has a plurality of rotation mechanisms as a plurality of joints in the arm, and can approach in various directions by the rotation of the rotation mechanism. Picking robot 40PC picks an article using two fingers of a hand. Picking robot 40PC can recognize the three-dimensional shape of the article based on the image captured by camera 60 by robot control system 30. Picking robot 40PC is good at picking an article having an irregular shape, for example.

Note that what each robot device 40 is good at is merely an example, and what each robot device is good at differs depending on various elements such as the type and size of the robot and the shape of the hand.

Therefore, for each type of picking robot 40P, there are an article that can be picked and an article that cannot be picked. Picking robots 40P of the respective types can complement characteristics related to picking feasibility of the other types of picking robots 40P. For example, certain article 1 can be picked by picking robot 40PA, picking robot 40PB, and picking robot 40PC. Certain article 2 can be picked by picking robot 40PA and picking robot 40PB. Certain article 3 can be picked by picking robot 40PB and picking robot 40PC. Certain article 4 can be picked by picking robot 40PC and picking robot 40PA.

In FIG. 1, warehouse management device 10 generates picking instruction data based on the picking list and transmits the picking instruction data to host management device 20. Host management device 20 includes a robot configuration database (robot configuration DB) 20D1 and an object database (object DB) 20D2. Robot configuration database 20D1 holds robot configuration information regarding the configuration of the robot. Object database 20D2 holds object information on the object. Host management device 20 has a sorting function of sorting bins 70 to any of the plurality of picking robots 40P based on the picking instruction data from warehouse management device 10 and the evaluation index related to the picking work. In addition, host management device 20 controls the operation of robot device 40 via robot control system 30 and controls the operation of camera 60.

### Environment in Warehouse

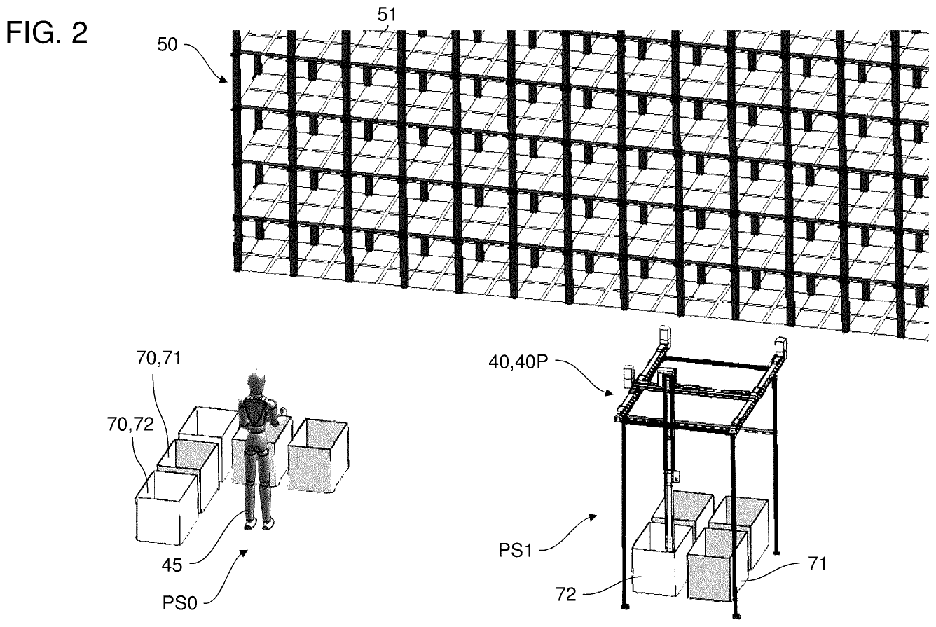

FIG. 2 is a diagram illustrating an example of an environment in warehouse 50.

Warehouse 50 is, for example, an automated warehouse. In warehouse 50, housing shelves 51 for housing bins 70 are arranged. Housing shelf 51 is planarly or spatially partitioned and can house a number of bins 70. For example, in response to a conveyance instruction from host management device 20, conveyance robot 40C conveys bin 70 housed in housing shelf 51 to one of the plurality of picking stations PS. Storage bin 71 is housed in housing shelf 51, and storage bin 71 may be conveyed from housing shelf 51 to predetermined picking station PS at a predetermined timing. Delivery bin 72 is, for example, around housing shelf 51, at a delivery station, or the like, and may be conveyed to predetermined picking station PS at a predetermined timing. Storage bin 71 and delivery bin 72 are conveyed to the picking stations sorted by the sorting function of host management device 20.

In each picking station PS, picking robot 40P or worker 45 that performs picking work is disposed. Picking station PS0 is a picking station where picking work is performed by a person. Picking station PS1 is a picking station where picking work is performed by picking robot 40P. Note that three or more picking stations PS may be provided. Further, a plurality of picking stations PS1 for picking robots 40P may be provided.

When the picking work in picking station PS is finished, conveyance robot 40C receives a conveyance instruction from host management device 20, for example, and conveys delivery bin 72 to a predetermined position (for example, a delivery station). The delivery station is, for example, a spatial region where an inspection of an object or boxing for delivery is performed.

The picking work is a work of picking (picking) an object from storage bin 71, moving object 80 to delivery bin 72, and disposing (placing) the object to delivery bin 72, that is, the picking work is a pick-and-place work.

### Configuration of Picking Station

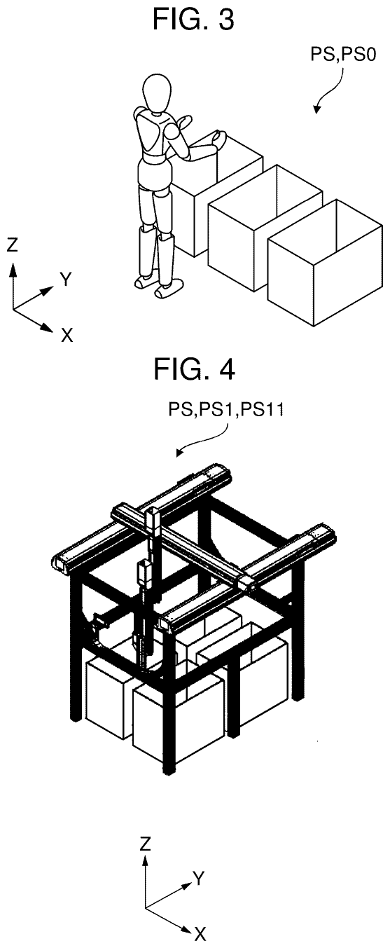

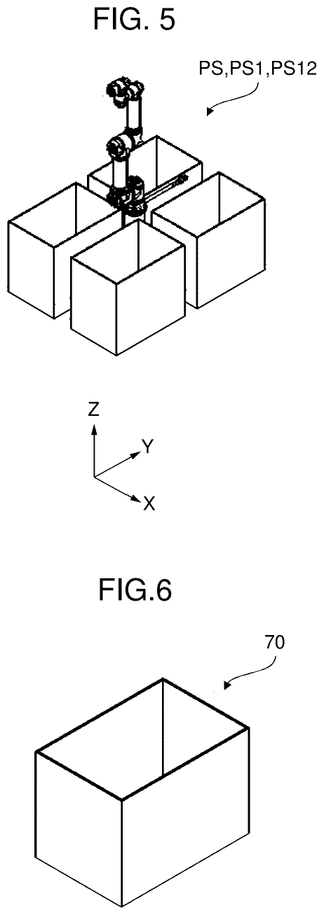

FIG. 3 is a diagram illustrating an example of picking station PS0 in which worker 45 is disposed. FIG. 4 is a diagram illustrating an example of picking station PS1 (PS11) in which picking robot 40PA or picking robot 40PB, each of which is an orthogonal robot, is disposed. FIG. 5 is an example of picking station PS1 (PS12) in which picking robot 40PC that is an articulated robot is disposed.

As illustrated in FIGS. 4 and 5, in picking station PS1(PS11,PS12) where picking robot 40P is disposed, two bins 70 are disposed in each of the X direction and the Y direction (that is, in a 2×2 shape) around the central portion of the picking robot. Four bins 70 include at least one storage bin 71 and at least one delivery bin 72. By arranging the plurality of bins 70 in the 2×2 shape in this manner, warehouse management system 5 can perform the picking work using other bins 70 also when replacing one bin 70, and thus, can efficiently perform the picking work and shorten the entire takt time. Note that the shape is not limited to 2×2, and more bins 70 may be arrangeable at the same time around picking robot 40P by being arranged in a shape of, for example, 2×3, 3×2, 3×3, or the like.

### Configuration of Bin

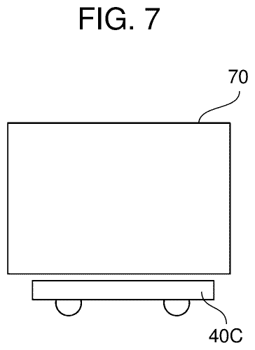

FIG. 6 is a diagram illustrating a configuration example of bin 70. Bin 70 has a substantially rectangular parallelepiped shape, and an article can be taken in and out from above. Therefore, picking robot 40P and worker 45 take an article in and out of bin 70 from above bin 70. FIG. 7 is a view illustrating an example of bin 70 and conveyance robot 40C that conveys bin 70. In FIG. 7, conveyance robot 40C moves bin 70 in a manner of pushing or pulling bin 70, but bin 70 may be placed on conveyance robot 40C and moved. As conveyance robot 40C, different conveyance robots 40C may be used for the storage bin conveyance and the delivery bin conveyance, or same conveyance robot 40C may be used.

### Arrangement of Camera

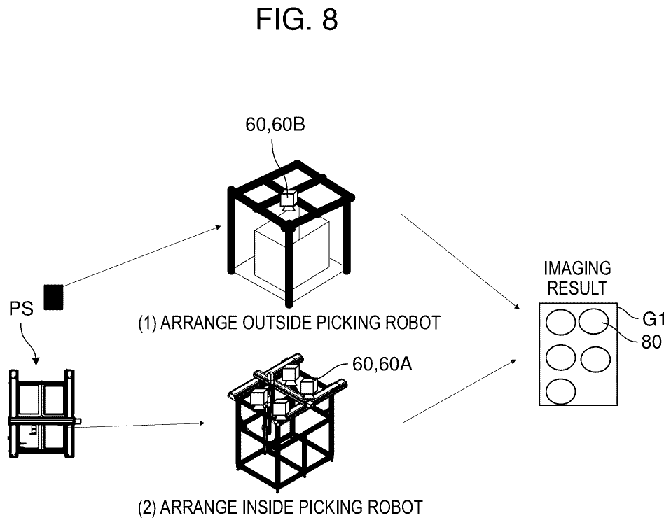

FIG. 8 is a diagram illustrating an arrangement image of camera 60. Camera 60 is disposed to be able to image the inside of bin 70. Camera 60 is used, for example, to recognize a state in bin 70. Camera 60 may be installed at picking station PS, for example, like camera 60A, and may be installed inside or outside in the vicinity of picking robot 40P. Furthermore, camera 60 may be disposed outside picking station PS, for example, like camera 60B. In captured image G1 captured by camera 60, for example, articles stored in storage bin 71 or delivery bin 72 are reflected, and how the articles are arranged can be grasped. In addition, since the presence or absence of storage bin 71 and delivery bin 72 is reflected in captured image G1 captured by camera 60A, it is possible to determine whether or not storage bin 71 and delivery bin 72 have arrived at picking station PS as the conveyance destination based on captured image G1. Note that only one camera 60 may be provided like camera 60A, or a plurality of cameras 60 may be provided like camera 60B.

### Configuration of Host Management Device

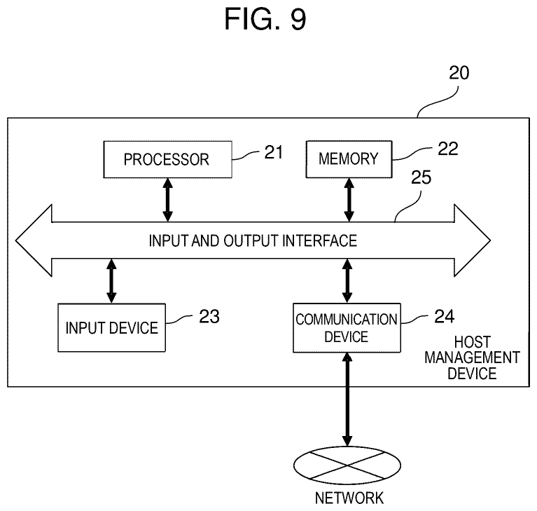

FIG. 9 is a block diagram illustrating a configuration example of host management device 20. Host management device 20 includes processor 21, memory 22, input device 23, communication device 24, and input/output interface 25.

Processor 21 may be configured using, for example, a central processing unit (CPU) or a digital signal processor (DSP). Processor 21 may be configured using various integrated circuits (for example, Large Scale Integration (LSI) or Field Programmable Gate Array (FPGA)). Processor 21 implements various functions by executing a program stored in memory 22. Processor 21 integrally controls each unit of host management device 20 and performs various types of processing. The processing by processor 21 may be processing in a cloud, for example.

Processor 21 acquires picking instruction data for instructing a picking work of an object. Processor 21 acquires an evaluation index related to the picking work for each object and each picking robot. The evaluation index includes, for example, a picking success rate indicating a success rate of the picking work for each object and each picking robot, and a takt time which is a time required for the picking work for each object and each picking robot. Processor 21 sorts bin 70 to one of a plurality of picking robots 40P based on the picking instruction data and the evaluation index. In this manner, processor 21 sorts bin 70 capable of storing the object of the picking work by picking robot 40P.

Memory 22 includes a primary storage device (for example, Random Access Memory (hereinafter, referred to as “RAM”) or Read Only Memory (hereinafter referred to as “ROM”)). Memory 22 may include a secondary storage device (for example, a hard disk drive (hereinafter, referred to as “HDD”) or a solid state drive (hereinafter, referred to as “SSD”)), a tertiary storage device (for example, an optical disk or an SD card), or the like. In addition, memory 22 may be an external storage medium or may be detachable from host management device 20. Memory 22 stores various data, information, programs, logs, or the like. Memory 22 includes robot configuration database 20D1 and object database 20D2.

Memory 22 stores, for example, picking instruction data, robot configuration information, object information, picking success rate information to be described later, takt time information to be described later, and picking result data to be described later. Memory 22 stores in advance, for example, the robot configuration information and the object information. Memory 22 may store, for example, picking success rate information and takt time information obtained as a calculation result and picking result data obtained from an external device.

Input device 23 may include various buttons, keys, a keyboard, a touch panel, a microphone, or other input devices. Input device 23 receives inputs of various data, information, and the like. Input device 23 is operated by, for example, an administrator who manages host management device 20.

Communication device 24 communicates various types of data, information, or the like according to a wired or wireless communication system. Communication device 24 may be communicatively connected to network NT. The communication system by communication device 24 may include a communication system such as a (local area network), a wide area network (WAN), a mobile phone network, or power line communication. Communication device 24 communicates with an external device (for example, warehouse management device 10 and robot control system 30). Communication device 24 receives, for example, picking instruction data from warehouse management device 10. Communication device 24 transmits, for example, picking instruction data to robot control system 30, and receives picking result data from robot control system 30.

Input/output interface 25 inputs and outputs information and data among processor 21, memory 22, input device 23, and communication device 24.

### Configuration of Robot Control System

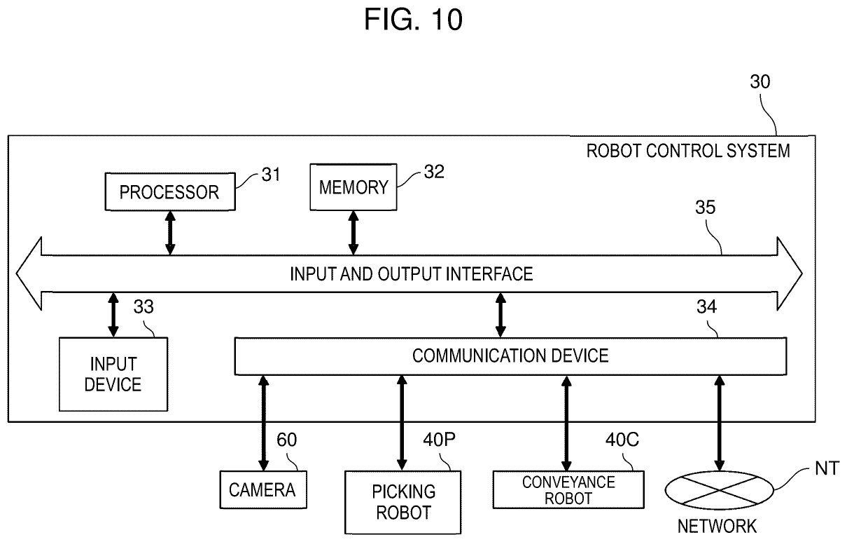

FIG. 10 is a block diagram illustrating a configuration example of robot control system 30. Robot control system 30 includes processor 31, memory 32, input device 33, communication device 34, and input/output interface 35.

Processor 31 may be configured using, for example, a CPU or a DSP. Processor 31 may be configured using various integrated circuits (for example, LSI or FPGA). Processor 31 implements various functions by executing a program stored in memory 32. Processor 31 integrally controls each unit of robot control system 30 and performs various types of processing.

Processor 31 controls operation of facility or device (for example, conveyance robot 40C, picking robot 40P, and camera 60) in a warehouse via communication device 34. For example, processor 31 may control the conveyance of bin 70 by conveyance robot 40C by controlling the travel of conveyance robot 40C. Processor 31 may control the picking work by picking robot 40P by controlling the operations of the arm and the hand of picking robot 40P. Processor 31 may control the picking work based on the picking instruction data from host management device 20.

Processor 31 acquires various types of information via input device 33 or communication device 34. For example, processor 31 acquires a captured image captured by camera 60 and detection information detected by the sensor. The processor may detect various events based on the acquired captured image, detection information, or the like. For example, processor 31 may recognize the presence or absence of an arrival of bin 70 at each picking station PS, the coordinates at which bin 70 is disposed at the picking station, and information on an article stored inside bin 70 (for example, the presence or absence, shape, weight, material, and size of the article). Processor 31 may generate at least some of the picking result data based on the recognized information.

Memory 32 includes a primary storage device (for example, a RAM or a ROM. Memory 32 may include a secondary storage device (for example, an HDD or an SSD), a tertiary storage device (for example, an optical disk or an SD card), or the like. Memory 32 may be an external storage medium or may be detachable from robot control system 30. Memory 32 stores various types of data, information, programs, or the like.

Input device 33 may include various buttons, keys, a keyboard, a touch panel, a microphone, a sensor, or other input devices. Input device 33 receives inputs of various types of data, information, and the like. Input device 33 may be operated by, for example, an administrator or worker 45 who manages robot control system 30. For example, the sensor may be provided inside or around the picking robot 40P for each picking robot 40P. For example, the sensor may be provided inside or around convey ance robot 40C for each conveyance robot 40C.

Communication device 34 communicates various types of data, information, or the like according to a wired or wireless communication system. The communication system by communication device 34 may include a communication system such as LAN, WAN, a mobile phone network, or power line communication. Communication device 34 communicates with an external device (for example, host management device 20).

Communication device 34 is communicably connected to camera 60, picking robot 40P, conveyance robot 40C, and the like in a wired or wireless manner. Communication device 34 sends an imaging instruction to camera 60, and acquires a captured image captured by camera 60 from camera 60. Communication device 34 sends an operation instruction for operating the robot arm, the hand, or the like to each picking robot 40P. Communication device 34 acquires information such as a position, an angle, or an attitude of a robot arm, a hand, or the like from each picking robot 40P. Communication device 34 sends a conveyance instruction of bin 70 to conveyance robot 40C, and acquires information such as the current position from conveyance robot 40C. Furthermore, communication device 34 is connected to network NT, and is communicably connected to, for example, warehouse management device 10 via network NT. Furthermore, communication device 34 may be communicably connected to camera 60, picking robot 40P, and conveyance robot 40C via network NT.

Input/output interface 35 inputs and outputs information and data among processor 31, memory 32, input device 33, and communication device 34.

Note that only one robot control system 30 may be provided, a plurality of robot control systems 30 may be provided, or one robot control system 30 may be provided for each facility in a warehouse such as robot device 40.

### Details of Information Handled by Host Management Device

Next, details of information handled by the host management device will be described.

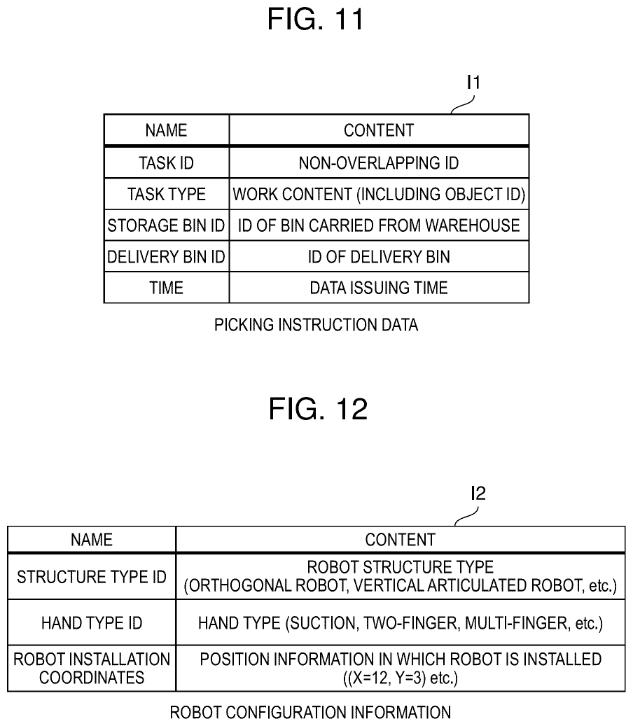

FIG. 11 is a diagram illustrating an example of picking instruction data I1. Picking instruction data I1 is instruction information related to picking instructed from warehouse management device 10. Picking instruction data I1 includes information on a task (work) ID, a task type, a storage bin ID, a delivery bin ID, and time. The task IDs are non-overlapping IDs (identification information). The task type is information indicating work content performed by robot device 40 or worker 45. The work content includes information such as an object ID of a picking target and the number of picking for each object. The storage bin ID is an ID of storage bin 71 to be transported from housing shelf 51. The delivery bin ID is an ID of the delivery bin. The information on the time is data issuing time when the picking instruction data is issued.

FIG. 12 is a diagram illustrating an example of robot configuration information I2. Robot configuration information I2 is held in robot configuration database 20D1. Robot configuration information I2 includes information on a structure type ID, a hand type ID, and robot installation coordinates. The structure type ID is information indicating the type (for example, orthogonal robots, vertical articulated robots, other types of structures) of the structure of picking robot 40P. The hand type ID is information indicating a type of a hand (for example, suction, two-finger, multi-finger, and other types of hands). The information on the robot installation coordinates is information indicating the position where the picking robot is installed, and is indicated by an X coordinate and a Y coordinate, for example, (X, Y)=(12,3).

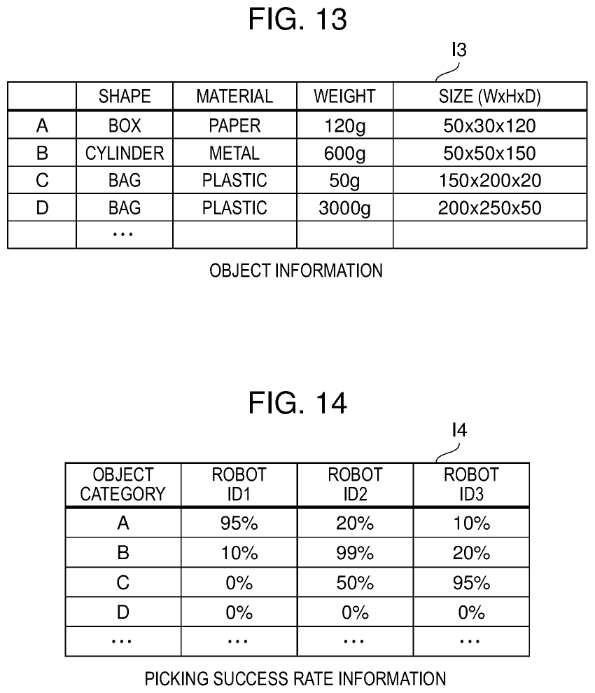

FIG. 13 is a diagram illustrating an example of object information I3. Object information I3 is held in object database 20D2. Object information I3 holds information on the shape of object 80, the material of object 80, the weight of object 80, and the size of object 80. The shape of object 80 is, for example, a shape such as a box, a cylinder, or a bag. The material of object 80 is, for example, paper, metal, plastic, or the like.

FIG. 14 is a diagram illustrating an example of picking success rate information I4. Picking success rate information I4 includes information on a picking success rate for each object category and for each robot ID. The picking success rate indicates a probability of having succeeded or succeeding in the picking work of the object. The picking success rate may be stored in memory 22 in advance for each object category and for each robot ID. The picking success rate may be calculated for each object category and each robot ID by processor 21 and stored in memory 22 as a calculation result. The robot ID is identification information indicating the type of picking robot 40P. The type of the picking robot may be determined by, for example, a hand type, or may be determined by combining the hand type and the structure type. The object category is classified according to characteristics (for example, shape, room, weight, size) of object 80 that may affect the picking work. Since the object category is determined for each object, it can be said that the picking success rate is determined for each object and for each picking robot 40P. Note that the object category may not be categorized by characteristics, but may be categorized for each type of each object.

In FIG. 14, information on a picking success rate based on a robot ID(for example, ID1, ID2, and ID3) and an object category (for example, A, B, C, and D) is stored. Robot ID1 indicates, for example, a suction type. Robot ID2 indicates, for example, a two-finger type. Robot ID3 indicates, for example, a three-finger type. In addition, picking success rate information I4 in FIG. 14 can be used as a predicted value in a case where the picking work is actually performed.

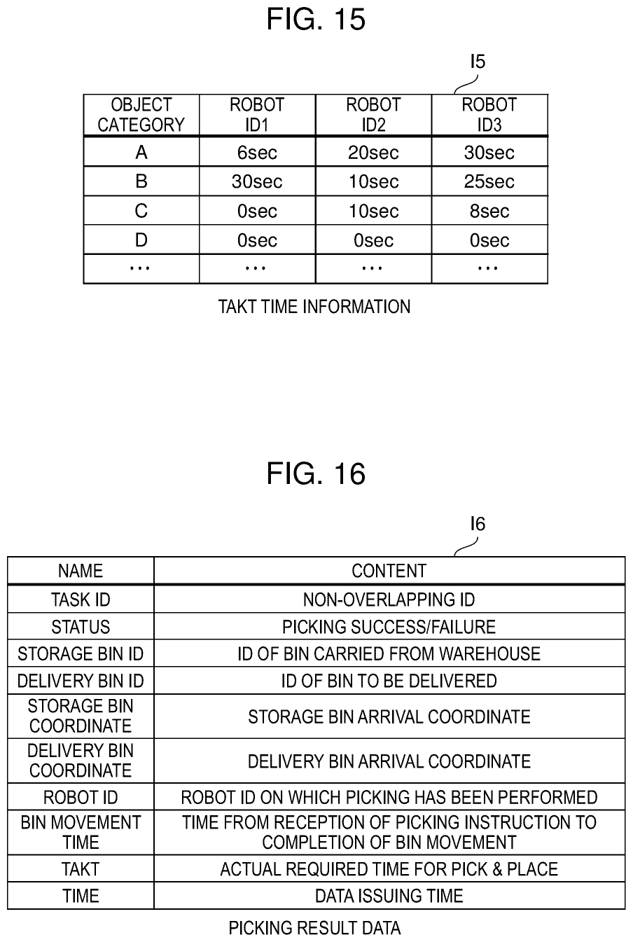

FIG. 15 is a diagram illustrating an example of takt time information I5. Takt time information I5 includes information on takt time for each object category and for each robot ID. The takt time may be stored in memory 22 in advance for each object category and for each robot ID. The takt time may be calculated for each object category and for each robot ID by processor 21 and stored in memory 22 as a calculation result. Since the object category is determined for each object, it can be said that the takt time is determined for each object and for each picking robot 40P.

The takt time in FIG. 15 is the time required for the picking work. The takt time here may be a time from a time point at which the pickup (picking) of predetermined object 80 from storage bin 71 is started to a time point at which object 80 is moved and the arrangement (placing) to delivery bin 72 is completed. That is, the time may be the time required for transferring one object from storage bin 71 to delivery bin 72. In addition, the takt time here may be a time from a time point when first object 80 is picked up from storage bin 71 to a time point when the arrangement of the last object to delivery bin 72 is completed for all objects 80 instructed by the picking instruction data. That is, it may be the time from the start to the completion of the arrangement in one delivery bin 72. In addition, the takt time here may be a time from when the picking instruction data is acquired to a time point when the arrangement of the last object to delivery bin 72 designated by the picking instruction data is completed. In this case, the takt time may include the movement time of bin 70.

In FIG. 15, takt time information based on robot IDs (for example, 1, 2, and 3) and object categories (for example, A, B, C, and D) is stored. In addition, takt time information I5 in FIG. 15 can be used as a predicted value in a case where the picking work is actually performed.

As the object category, there is a category of having a box shape and being lightweight, and an article such as a box containing medicine belongs to the object category. In addition, as the object category, there is a category of having a box shape and having a weight, and for example, an article such as corrugated cardboard containing PET bottles of drinking water belongs to the object category. In addition, as the object category, there is a category of having a bag shape and being lightweight, and an article such as a towel belongs to the object category. In addition, as the object category, there is a category of having a bag shape and having weight, and an article such as a bag containing sugar belongs to the object category. In addition, as the object category, there is a category of having an irregular shape, and an article such as a bag having an uneven shape belongs to the object category.

For example, in a case where the object has a simple shape such as a box shape, there are circumstances that object recognition based on the captured image is simple, the recognition speed becomes high, and gripping by the hand is easy, and the takt time tends to be short. In addition, in a case where the object has an irregular shape, there are circumstances that object recognition based on the captured image is difficult, the recognition speed becomes low, and approach with an arm or gripping by the hands needs to be performed carefully, and the takt time tends to be long.

FIG. 16 is a diagram illustrating an example of picking result data I6. Picking result data I6 is data obtained as a result of performing the picking work. Picking result data I6 includes information of a task ID, a status, a storage bin ID, a delivery bin ID, storage bin coordinates, delivery bin coordinates, a robot ID, a bin movement time, a takt time, and a time. Here, the storage bin ID is an ID of storage bin 71 transported from housing shelf 51. Here, the delivery bin ID is an ID of delivery bin 72 transported from housing shelf 51. Here, the storage bin coordinates are coordinates of a position at which storage bin 71 arrives and is disposed at picking station PS as a conveyance destination. Here, the delivery bin coordinates are coordinates of a position where delivery bin 72 arrives and is disposed at picking station PS as the conveyance destination. Here, the robot ID is an ID of picking robot 40P that has performed the picking work of object 80. The bin movement time here is a time required from the reception time point of picking instruction data I1 to the movement completion time point of bin 70. The takt time here is an actual time required for picking work (pick and place), that is, an actual measurement value of the takt time. The information on time is information indicating the time when picking result data I6 is issued.

Picking result data I6 is derived (for example, detected or calculated) by robot control system 30 and transmitted to host management device 20, that is, fed back as result information for the picking instruction data. Host management device 20 acquires picking result data I6 from robot control system 30, and stores picking result data I6 in memory 22. In addition, host management device 20 may cause processor 21 to update the picking success rate information and the takt time information based on fed back picking result data I6.

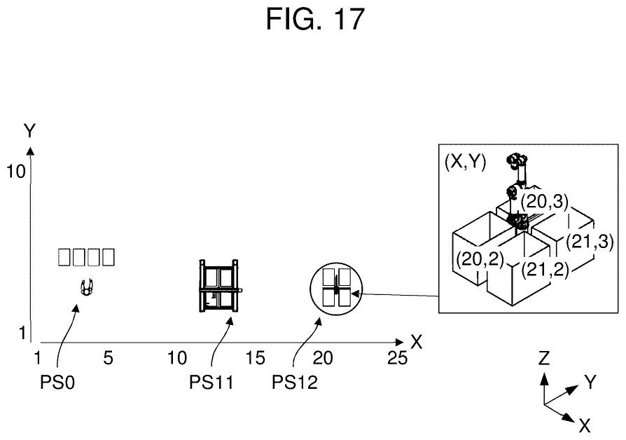

FIG. 17 is a diagram illustrating an example of storage bin coordinates and delivery bin coordinates. In FIG. 17, for example, three storage bins 71 and one delivery bin 72 are arranged around picking robot 40PC disposed in picking station PS12. The storage bin coordinates of three storage bins 71 are (X, Y)=(20,2), (20,3), (21,3), respectively. The delivery bin coordinates of one delivery bin 72 are (X, Y)=(21,2).

### Operation of Warehouse Management System

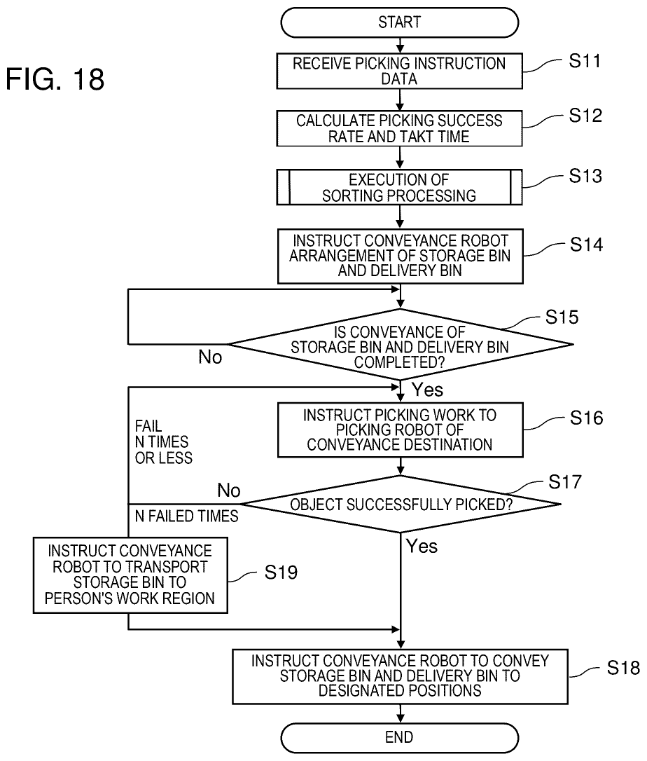

FIG. 18 is a flowchart illustrating an operation example of host management device 20.

Communication device 24 receives the picking instruction data from warehouse management device 10 (S11). Processor 21 calculates the picking success rate and the takt time for each object category and for each picking robot based on the picking instruction data, the robot configuration information, and the object information (S12). For example, processor 21 calculates, by simulation, the picking success rate and the takt time when the picking work is performed on the object instructed by the picking instruction data. The picking success rate and the takt time may not be calculated every time, and data recorded in memory 22 may be used.

Robot control system 30 manages information related to the picking work for each picking robot 40P. For example, processor 31 recognizes a task amount of each picking robot 40P using a sensor or the like as input device 33. The task amount is, for example, an amount of tasks to be performed by picking robot 40P (for example, the number of objects that need to be picked). For example, robot control system 30 can recognize the number of remaining objects for each picking robot 40P, based on the number of objects on which picking robot 40P is instructed to perform work and the number of picked objects derived based on detection information of a sensor of picking robot 40P or a captured image by camera 60. Processor 31 transmits information on the task amount of each picking robot 40P to host management device 20 via communication device 34. Processor 21 of host management device 20 acquires information on the task amount of each picking robot 40P via communication device 24. Note that processor 21 itself of host management device 20 may recognize the task amount for each picking robot 40P.

Processor 21 executes sorting processing of sorting the conveyance destination of bin 70 to any one of the plurality of picking robots 40P based on the picking success rate and the takt time obtained in step S12 and the task amount (S13). The sorting processing is synonymous with the processing of determining picking robot 40P that performs the picking work of object 80 instructed by the picking instruction data. Details of the sorting processing will be described later.

Processor 21 instructs conveyance robot 40C to arrange storage bin 71 in which the object instructed by the picking instruction data is stored in picking robot 40P as the sorting destination (S14). In this case, processor 21 may instruct the conveyance from the housing position of storage bin 71 to the target arrangement position of the picking work based on the storage bin ID. Here, the target arrangement position of storage bin 71 is picking station PS in which picking robot 40P as the sorting destination is disposed, and is the periphery of picking robot 40P.

Processor 21 instructs conveyance robot 40C to arrange delivery bin 72 for delivering object 80 instructed by the picking instruction data in picking robot 40P as the sorting destination (S14). In this case, processor 21 instructs, via communication device 24, conveyance from the housing position of delivery bin 72 to a target arrangement position of the picking work based on the delivery bin ID. Here, the target arrangement position of delivery bin 72 is picking station PS in which picking robot 40P of the sorting destination is arranged, and is the periphery of picking robot 40P. In steps S13 and S14, storage bin 71 and delivery bin 72 are conveyed to same picking station PS.

Processor 21 determines whether or not the conveyance of storage bin 71 and delivery bin 72 to the above-described predetermined arrangement positions is completed (S15). In this case, processor 21 may recognize that the conveyance of storage bin 71 and delivery bin 72 to the predetermined arrangement position is completed by receiving the arrival information indicating that conveyance robot 40C has arrived at the predetermined arrangement position via communication device 24. Furthermore, processor 21 may acquire a captured image from camera 60 via communication device 24 and recognize that the conveyance to the predetermined arrangement position has been completed based on the captured image.

When the conveyance of storage bin 71 and delivery bin 72 to the predetermined arrangement positions is not completed (No in step S15), processor 21 executes the process of step S15 again. That is, processor 21 waits until the conveyance to the predetermined arrangement positions of storage bin 71 and delivery bin 72 is completed.

When the conveyance to the predetermined arrangement positions of storage bin 71 and delivery bin 72 is completed (Yes in step S15), processor 21 instructs, via communication device 24, picking robot 40P disposed in picking station PS as the conveyance destination to perform the picking work of object 80 from storage bin 71 to delivery bin 72 (S16).

Note that, at the time of step S14, processor 21 may transmit an instruction of picking work to picking robot 40P as the conveyance destination (sorting destination) via communication device 24 and robot control system 30.

In this case, in robot control system 30, processor 31 may acquire, via communication device 34, the notification information of the conveyance completion from conveyance robot 40C, and the detection information indicating the detection of the conveyance completion of convey ance robot 40C by the sensor serving as input device 33 (that is, the information indicating the detection of storage bin 71 or delivery bin 72 around picking robot 40P). Processor 31 determines the timing of picking the object from storage bin 71 by picking robot 40P based on the acquired information. Then, communication device 34 may notify picking robot 40P as the conveyance destination of the picking timing. As a result, picking robot 40P can pick the object at an appropriate timing even when the instruction of the picking work has been given at an early stage.

Picking robot 40P as the conveyance destination performs the picking work of the object according to the instruction of the picking work from host management device 20. The state of the picking work is imaged by camera 60. Processor 31 of robot control system 30 determines whether or not picking robot 40P has succeeded in the picking work based on the image captured by camera 60 (S17). For example, in a case where processor 31 recognizes that the object stored inside storage bin 71 has been moved and stored inside delivery bin 72 as a result of the image recognition of the captured image by camera 60, it is determined that the picking work has been successful. Communication device 34 transmits picking result data including picking success/failure information indicating success/failure of the picking work to host management device 20. Then, processor 21 of host management device 20 may determine whether or not the picking work has been successful by receiving the picking result data via communication device 24.

In addition, robot control system 30 may detect that the picking work by picking robot 40P at the conveyance destination has been completed using a sensor, and transmit the detection information to host management device 20. Then, processor 21 of host management device 20 may determine that the picking work has been successful by receiving the picking work completion information via communication device 24.

If it is determined that the picking work of the object has been successful (Yes in step S17), processor 21 instructs conveyance robot 40C to convey storage bin 71 and delivery bin 72 to designated positions via communication device 24 (S18). The designated position for storage bin 71 here is, for example, any position in housing shelf 51. The designated position for delivery bin 72 here is, for example, any position in the delivery station.

On the other hand, when it is determined that the picking work of the object has failed (No in step S17), processor 21 proceeds to step 16 until N times of failure. That is, in step S16, processor 21 repeats the picking work of the object up to N times. When the picking work of the object has failed N times (Nth No in step S17), processor 21 instructs conveyance robot 40C via communication device 24 to convey storage bin 71 in which the object for which the picking work has failed is stored and delivery bin 72 in which the object is transferred and stored to picking station PS0 which is a work region of a person (S19).

As a case where the picking work of the object fails N times, for example, it is conceivable that the result of the derivation simulation of the picking index value to be described later in the sorting processing of step S13 is wrong.

After step S19, the picking work of the object is performed by worker 45 in picking station PS0. At this time, processor 21 transmits a work instruction of the picking work to a display or the like installed in a work region (picking station PS0) of worker 45 via communication device 24. The display receives and displays a work instruction of the picking work. As a result, worker 45 can confirm detailed information regarding the picking work of the object.

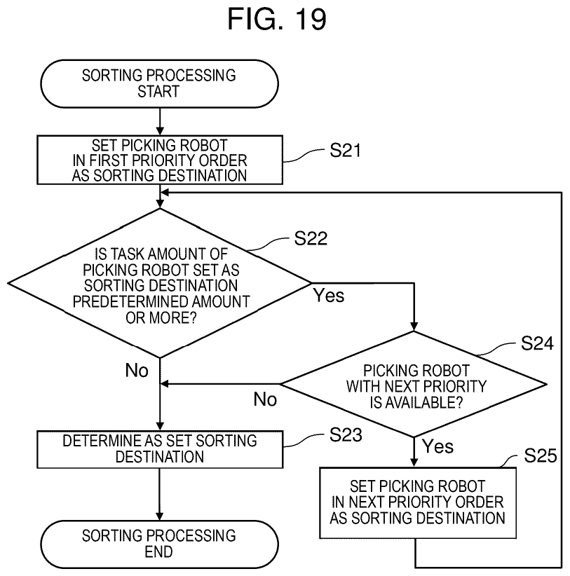

FIG. 19 is a flowchart illustrating an example of details of the sorting processing in step S13 of FIG. 18.

Processor 21 of host management device 20 determines the priority order of picking robots 40P to sort bins 70 based on the picking success rate and the takt time obtained in step S11. In this case, processor 21 may determine the priority order such that the smaller the picking index value (=takt time/picking success rate), which is a value obtained by dividing the takt time by the picking success rate, the higher the priority order. Processor 21 may determine picking robot 40P to which bin 70 is to be sorted based on the priority order and the task amount of picking robot 40P. Therefore, in a case where the task amount of picking robot 40P scheduled to be sorted (for example, having a high priority) is large, processor 21 may sort bin 70 to other picking robots 40P capable of picking the same or similar objects.

Processor 21 sets the picking robot (for example, picking robot 40P having the suction hand) having the first priority as the sorting destination as picking robot 40P to be sorted (S21). Processor 21 determines whether or not the task amount of picking robot 40P set as the sorting destination is a predetermined amount or more (S22).

When the task amount is less than the predetermined amount (No in step S22), processor 21 determines picking robot 40P set as the sorting destination as picking robot 40P as the sorting destination (S23).

When the task amount of picking robot 40P set as the sorting destination is equal to or more than the predetermined amount (Yes in step S22), processor 21 determines whether or not picking robot 40P (for example, picking robot 40P having the two-finger hand) having the next priority (for example, the second priority) can pick the object that set picking robot 40P is scheduled to pick (S24). Whether or not picking is possible here may be determined, for example, by whether or not a picking success rate of the same object or an object having similar characteristics is a predetermined value or more.

When picking robot 40P having the next priority can perform picking (Yes in step S24), processor 21 sets picking robot 40P having the next priority as picking robot 40P as the sorting destination (S25). Then, the process proceeds to step S22.

When picking robot 40P having the next priority cannot be picked (No in step S24), processor 21 determines picking robot 40P set as the sorting destination as picking robot 40P of the sorting destination (S23).

According to the operation examples of FIGS. 18 and 19, host management device 20 can determine picking robot 40P as the sorting destination of bin 70 based on the evaluation index (for example, a picking success rate and a takt time) related to the picking work of each picking robot 40P. Therefore, host management device 20 can determine picking robot 40P estimated to be capable of picking at high speed and with high accuracy as the sorting destination of bin 70.

In addition, host management device 20 can determine picking robot 40P of the sorting destination in consideration of the task amount. For example, host management device 20 can set (temporarily determine) picking robot 40P of the sorting destination based on the picking index value, and determine (formally determine) picking robot 40P of the sorting destination in consideration of the set task amount of picking robot 40P. That is, in a case where the task amount scheduled to be performed by picking robot 40P is large, the picking work can be sorted to another picking robot 40P capable of picking the object. Therefore, host management device 20 can avoid the occurrence of the waiting time of the picking work in picking robot 40P for which the sorting destination is initially set. Therefore, host management device 20 can shorten the entire takt time for performing the picking work on all the objects to be picked.

When calculating the picking success rate and the takt time, processor 21 of host management device 20 may store the picking success rate and the takt time in memory 22 so that the picking success rate and the takt time can be used for sorting bins 70 in the next and subsequent times. In addition, processor 21 may store the past actual values of the picking success rate and the takt time in memory 22 so that the past actual values can be used for sorting bins 70 at a later timing. In these cases, host management device 20 can make it unnecessary to calculate the picking success rate and the takt time when sorting bins 70.

Next, another example in a case where the picking work by picking robot 40P is difficult will be described.

Here, it is assumed that picking robot 40P set as the sorting destination cannot pick the object instructed by the picking instruction data. Here, it is assumed that none of picking robots 40P can pick the object, and the picking success rate is 0%.

In a case where the picking success rate of any of picking robots 40P is 0%, the picking index value (takt time/picking success rate) cannot be obtained. Therefore, there is no picking robot 40P having the minimum picking index value. In this case, processor 21 of host management device 20 determines worker 45 as a picking means of the sorting destination.

Processor 21 instructs, via communication device 24, conveyance robot 40C to convey storage bin 71 and delivery bin 72 to the arrangement position of worker 45 (picking station PS0). This processing corresponds to step S19 in FIG. 18. After step S19, the picking work of the object is performed by worker 45 in picking station PS0.

### Movement of Bin

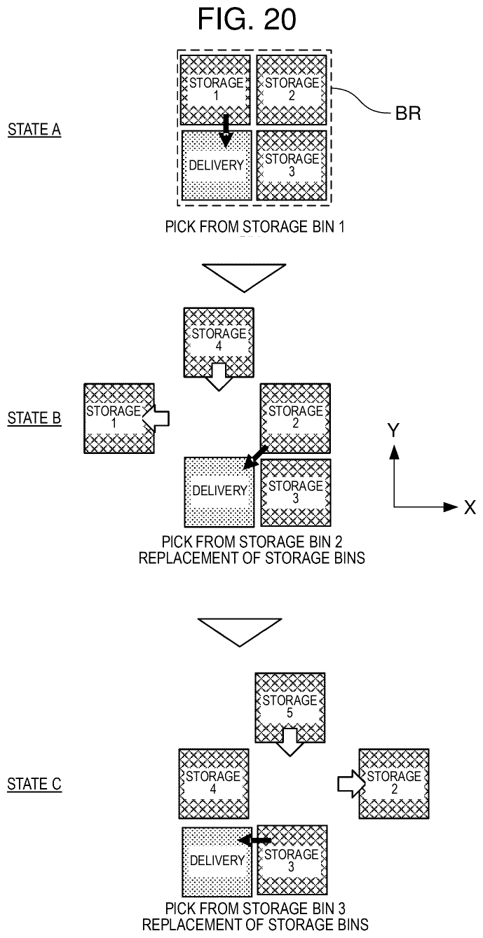

FIG. 20 is a diagram illustrating an example of movement of bin 70 at the time of picking work.

In FIG. 20, the plurality of storage bins 71 are described as “storage bins x” (where x is a natural number), and are also simply described as “storage x”. In FIG. 20, delivery bin 72 is also simply referred to as “delivery”. In the initial state, storage bin 1, storage bin 2, storage bin 3, and delivery bin 72 are arranged in a 2×2 shape in bin arrangement region BR around picking robot 40.

First, in state A, replacement (picking work) from storage bin 1 to delivery bin 72 is performed.

In state B, storage bin 1 from which the object has been picked is separated to the negative side in the X direction, and new storage bin 4 approaches from the positive side in the Y direction with respect to the position where storage bin 1 was disposed, and is disposed at the position of original storage bin 1. During such movement of storage bins 1 and 4, a picking work from storage bin 2 to delivery bin 72 is performed.

In state C, storage bin 2 from which the object has been picked is separated to the positive side in the X direction, and new storage bin 5 approaches from the positive side in the Y direction with respect to the position where storage bin 2 has been disposed, and is disposed at the position of original storage bin 2. During such movement of storage bins 2 and 5, a picking work from storage bin 3 to delivery bin 72 is performed.

As described above, in the present exemplary embodiment, the movement of one or more storage bins 71 and the picking work using other one or more storage bins 71 and delivery bins 72 can be performed in overlapping timing, and the conveyance of bins 70 and the picking work can be efficiently performed. Therefore, warehouse management system 5 can shorten the total time of the bin moving time and the takt time when the picking work of the object from the plurality of storage bins 71 to delivery bin 72 is performed.

According to warehouse management system 5 of the first exemplary embodiment, bins 70 can be appropriately sorted to the plurality of picking robots 40P. Warehouse management system 5 can improve the coverage ratio of objects that can be picked in the automated warehouse having picking robots 40P having two or more types of different configurations capable of picking work and movable bins 70, and can shorten the time of the picking work. In this case, with respect to the picking instruction data (storage bins, delivery bins, quantities, etc., of objects), host management device 20 can realize the minimization of one work takt and a plurality of work takts, perform outputting, and appropriately control the arrangement of movable bins 70 according to the configuration of the robots, the arrangement of the robots, and the evaluation index of picking of the robot (the gripping success rate and the work takt).

### Background to Obtain a Second Exemplary Embodiment

In the information processing method of Patent Literature 1, how to arrange the shelf conveyed by the automatic conveyance vehicle with respect to the picking means that performs the picking work is not considered. Therefore, when there is a plurality of shelves used for the picking work, the time required for the picking work becomes long depending on the positional relationship of the plurality of shelves.

In the second exemplary embodiment, for example, a bin arrangement control method and a bin arrangement control device capable of shortening the time required for the picking work when the picking work of moving the object from the storage bin to the delivery bin is performed using the picking robot will be described.

### Second Exemplary Embodiment

In a second exemplary embodiment, the warehouse management system controls the arrangement of each bin conveyed to the picking station. Further, in the second exemplary embodiment, regarding items similar to those described in the first exemplary embodiment, a description thereof will be omitted or briefly given.

### Configuration of Warehouse Management System

Warehouse management system 5A in the second exemplary embodiment has the same configuration as warehouse management system 5 in the first exemplary embodiment. Note that warehouse management system 5A includes host management device 20A instead of host management device 20, and includes robot control system 30A instead of robot control system 30.

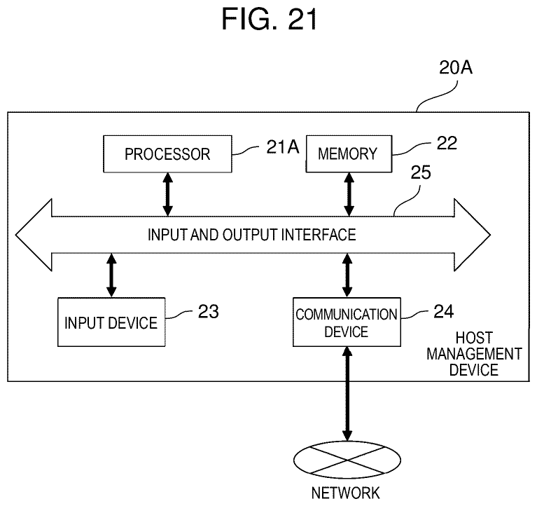

FIG. 21 is a block diagram illustrating a configuration example of host management device 20A according to the second exemplary embodiment. Host management device 20A has the same configuration as host management device 20 of the first exemplary embodiment. Note that host management device 20A includes processor 21A instead of processor 21.

Processor 21A has a function similar to that of processor 21 of the first exemplary embodiment. In addition, processor 21A controls the arrangement of bins 70 with respect to predetermined picking robot 40P. In this case, processor 21A determines the positional relationship between storage bin 71 and delivery bin 72 based on, for example, the characteristic of the object, the number and the arrangement state of the articles arranged inside bin 70, or the arrangement position of the object in storage bin 71 and the arrangeable position of the object after the movement in delivery bin 72. Furthermore, in this case, the movement distance of the hand of the picking robot may be calculated based on the arrangement position of the object in storage bin 71 and the arrangeable position of the object after the movement in delivery bin 72, and the positional relationship may be determined based on the movement distance of the hand.

Processor 21A controls the arrangement of storage bin 71 and delivery bin 72 with respect to picking robot 40P based on the determined positional relationship. For example, processor 21A determines the arrangement positions of storage bin 71 and delivery bin 72 with respect to picking robot 40P. This arrangement position is an arrangement position of storage bin 71 and delivery bin 72 in bin arrangement region BR of picking station PS in which picking robot 40P is disposed. The arrangement position of storage bin 71 is defined by the storage bin coordinates and the arrangement position of delivery bin 72 is defined by the delivery bin coordinates.

Note that predetermined picking robot 40P may be picking robot 40P as the sorting destination determined in the first exemplary embodiment, or may be picking robot 40P as the sorting destination determined by another method. The characteristic of the object is, for example, a shape, a material, a weight, a size, or the like included in object information I3 illustrated in FIG. 13.

Processor 21A may acquire the captured image from camera 60 via communication device 24, and may acquire various types of detection information from the sensor. Processor 21A recognizes the arrangement state and the like of the article inside bin 70 (for example, storage bin 71 and delivery bin 72) based on the captured image or the detection information. Note that the recognition of the arrangement state of the article or the like based on the captured image or the detection information described here may be performed by robot control system 30A. In this case, processor 21A may recognize the arrangement state of the article in bin 70 by acquiring recognition information including a result of this recognition from robot control system 30A via communication device 24.

Processor 21A updates picking instruction data I1 by adding the storage bin coordinate and the delivery bin coordinate to picking instruction data I1 based on the determined arrangement positions of storage bin 71 and delivery bin 72 to generate picking instruction data I1A.

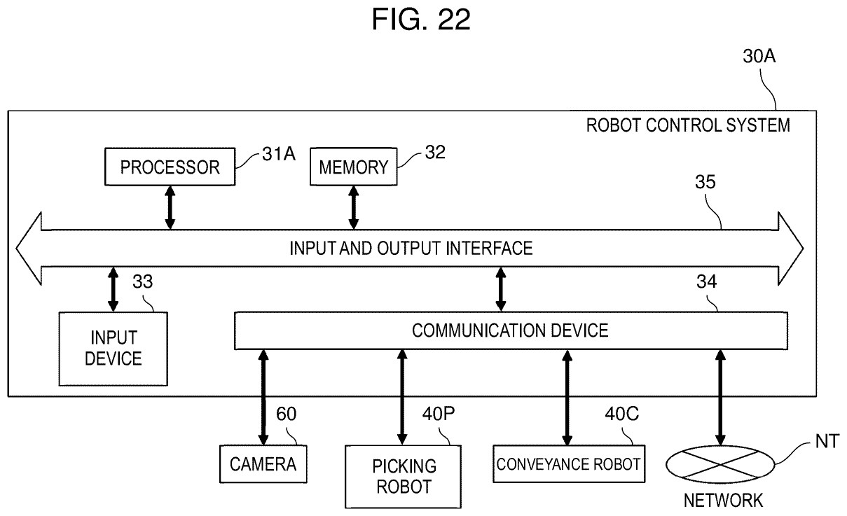

FIG. 22 is a block diagram showing a configuration example of robot control system 30A of the second exemplary embodiment. Robot control system 30A has the same configuration as robot control system 30 of the first exemplary embodiment. Note that robot control system 30A includes processor 31A instead of processor 31.

Processor 31A has a function similar to that of processor 31 of the first exemplary embodiment. Furthermore, processor 31A recognizes, for example, the arrangement state of the article in bin 70 based on the captured image acquired from camera 60, the detection information acquired from the sensor, or the like. The information of the recognition result is transmitted as recognition information by communication device 34 to host management device 20A.

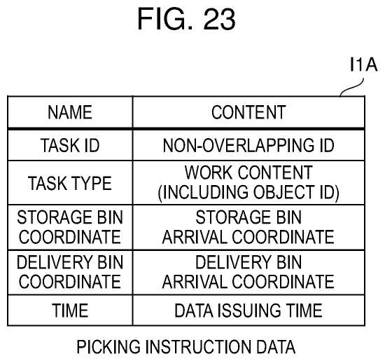

FIG. 23 is a diagram illustrating updated picking instruction data I1A. In FIG. 23, description of matters similar to picking instruction data I1 illustrated in FIG. 4 is omitted or simplified. Picking instruction data I1A includes information of a task ID, a task type, storage bin coordinates, delivery bin coordinates, and time. The storage bin coordinates are coordinates of a position where storage bin 71 arrives at picking station PS as a conveyance destination and is scheduled to be arranged. The delivery bin coordinates are coordinates of a position where delivery bin 72 arrives at picking station PS as a conveyance destination and is scheduled to be arranged.

### Operation of Warehouse Management System

Next, an operation example of the picking work of the present exemplary embodiment will be described.

When the picking work by picking robot 40P is subdivided, for example, the following processing is included. The picking work by picking robot 40P is performed, for example, in accordance with an instruction of control by robot control system 30. The picking work includes, for example, as processing at the time of picking, content recognition of picking instruction data, recognition of an object of the picking work, movement of an arm (hand) to the object in storage bin 71, waiting for vibration convergence of the arm after the movement, and picking (for example, suction or gripping) of the object by the hand. In addition, the picking work includes, as processing at the time of placing, recognition of an arrangeable position of the picked object in delivery bin 72, movement of the arm (hand) to the arrangeable position of the object in delivery bin 72, waiting for vibration convergence of the arm after the movement, and placing (arranging) the object to the arrangeable position by the hand. The movement of the arm includes movement in the XY direction and movement (lowering and raising) in the Z direction. Since the hand is installed at the distal end portion of the arm, the hand operates in conjunction with the operation of the arm. The hand can also perform operation independently of the arm.

In the subdivided processing in the picking work, it takes a relatively long time to perform picking processing, movement of the arm (hand), and placing processing. In the present exemplary embodiment, warehouse management system 5 shortens at least the movement time required for the movement of the hand holding the object at the time of the picking work. The moving speed of the hand is controlled (also referred to as ramp-up/down control) so as to gradually increase from the speed 0 at the start of movement to become the target speed, and gradually decrease from the target speed to become the speed 0 at the end of movement. Examples of the factors that affect the movement time of the hand include the way of putting the object into delivery bin 72, the size of the object, and the weight of the object.

The moving speed of the hand in the X and Y directions may vary depending on how the object is put into delivery bin 72. The way of putting the object into delivery bin 72 is a positional relationship between the arrangement position of the object in storage bin 71 and the arrangeable position of the object after the movement in delivery bin 72. For example, the longer the distance from the arrangement position of the object in storage bin 71 to the arrangeable position of the object in delivery bin 72, the longer the movement distance of the hand in the X and Y directions and the longer the movement time of the hand in the X and Y directions. On the other hand, the shorter the distance from the arrangement position of the object in storage bin 71 to the arrangeable position of the object in delivery bin 72, the shorter the movement distance of the hand in the X and Y directions and the shorter the movement time of the hand in the X and Y directions.

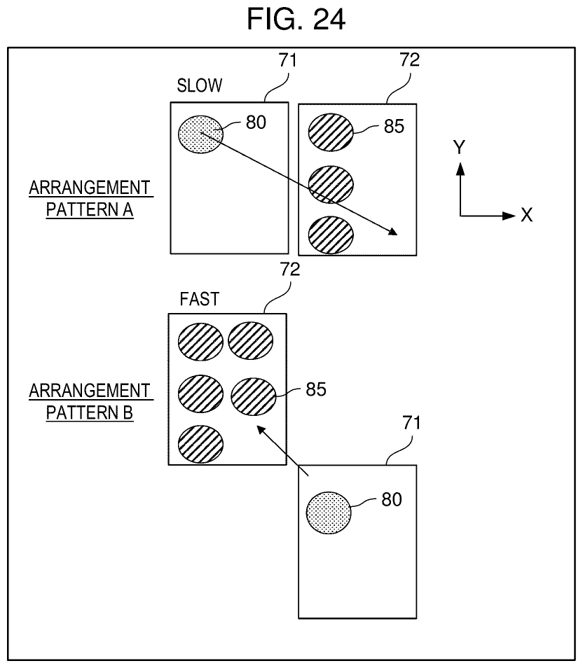

FIG. 24 is a diagram illustrating an image of the movement time of the hand in the X and Y directions according to the arrangement relationship between storage bin 71 and delivery bin 72. In FIG. 24, in arrangement pattern A, storage bin 71 and delivery bin 72 are arranged side by side in the X direction, and the hand needs to move object 80 over a long distance by passing above another article 85. In arrangement pattern B, storage bin 71 and delivery bin 72 are arranged side by side in the diagonal direction, and the hand only needs to move object 80 for a short distance without passing above another article 85.

The movement time of the hand in the Z direction may vary depending on the size of the object or the number of articles in bin 70. The larger the size of the object or the larger the number of articles in storage bin 71, the faster the moving speed of the arm in the Z direction and thus the shorter the movement time of the arm. This is because the movement distance of the arm in the Z direction decreases when the articles are placed in an overlapping manner in the Z direction. Similarly, also when the number of articles in delivery bin 72 is large, the movement time of the arm in the Z direction is shortened. This is because the object is disposed to overlap in the Z direction. On the other hand, the smaller the size of the object, the smaller the number of articles in storage bin 71, or the smaller the number of articles in delivery bin 72, the faster the moving speed of the arm in the Z direction.

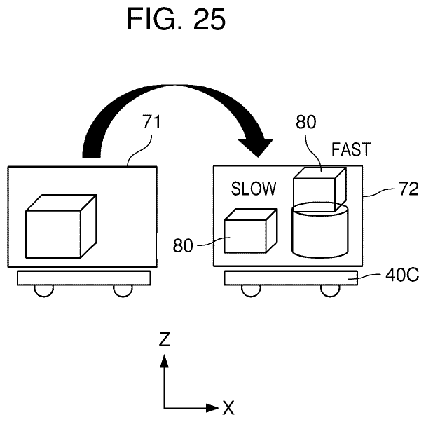

FIG. 25 is a diagram illustrating an image of the moving speed of the hand in the Z direction. In FIG. 25, in a case where the object is arranged on another article 85, the movement distance of the hand becomes short, and thus, the moving speed becomes high, and in a case where the object is not arranged on another article 85, the movement distance of the hand becomes long.

For example, based on the recognized arrangement state of the article, processor 21 determines whether object 80 is overlaid on article 85 in storage bin 71, that is, whether object 80 is arranged at a high position in the Z direction. In a case where object 80 is arranged at a high position, even if storage bin 71 in which object 80 is stored and delivery bin 72 are not arranged side by side in the X direction or the Y direction but are arranged in the diagonal direction, it is possible to suppress an increase in the time for the picking work. Similarly, based on the recognized arrangement state of the article, processor 21 determines whether object 80 is overlaid on article 85 in delivery bin 72, that is, whether object 80 can be arranged at a high position in the Z direction. In a case where object 80 can be arranged at a high position, storage bin 71 and delivery bin 72 in which the object is stored are not arranged side by side in the X direction or the Y direction, and even if the storage bin and the delivery bin are arranged in the diagonal direction, it is possible to suppress an increase in the time for the picking work.

The movement time of the hand in each of the X, Y, and Z directions in a state where the hand picks the object may be different depending on the weight of the object. As the weight of the object is heavier, the moving speed of the hand in the X, Y, and Z directions in a state where the object is picked becomes slower, and thus the movement time of the hand becomes longer. This is because as the weight is heavier, the acceleration in the above ramp-up/down control is smaller. On the other hand, as the weight of the object is lighter, the moving speed of the hand in each of the X, Y, and Z directions in a state where the object is picked becomes faster, and thus the movement time of the arm becomes shorter.

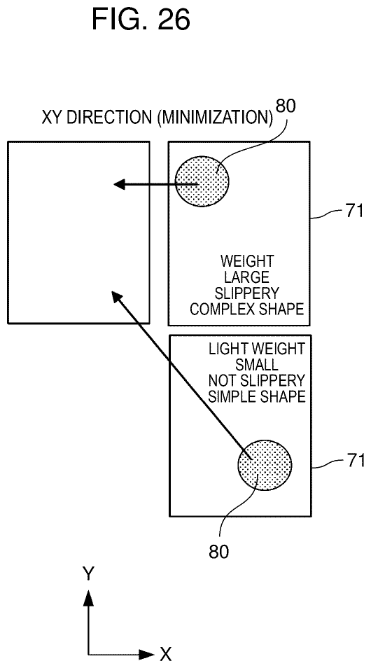

FIG. 26 is a diagram illustrating an image of movement of an object according to the characteristic of the object. In FIG. 26, host management device 20 can shorten the movement time of the hand and shorten the takt time by making the movement distance of the heavy object shorter than the movement distance of the light object. The same applies to not the characteristic that the weight is heavy but the characteristic that the size of the object is large, the material of the object is slippery, and the shape of the object is a simple shape. In this case, host management device 20 can suppress an increase in the time of the picking work by arranging storage bin 71 and delivery bin 72 close to each other, for example, adjacent to each other in the X direction or the Y direction. On the other hand, in the case of the characteristics that the weight of the object is light, the size of the object is small, the material of the object is difficult to slip, and the shape of the object is a complicated shape, the moving speed of the hand can be increased, and the movement time of the hand can be shortened. Therefore, even if storage bin 71 and delivery bin 72 are arranged to be slightly separated from each other, for example, even if they are arranged in the diagonal direction, it is possible to suppress an increase in the time of the picking work.

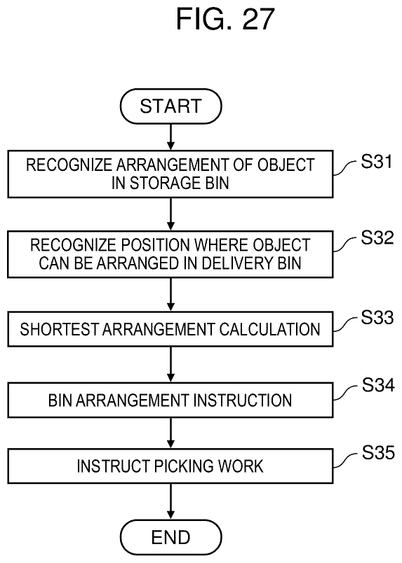

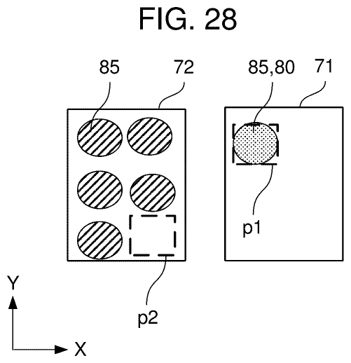

FIG. 27 is a flowchart illustrating an operation example of host management device 20.

It is assumed that each bin 70 is located in the vicinity of picking robot 40P that performs the picking work at the processing start time point of FIG. 27.

Processor 21 acquires an image captured by camera 60 via communication device 24. In this captured image, the article in storage bin 71 is reflected. Processor 21 recognizes an arrangement state of the article in storage bin 71 based on the captured image. At this time, processor 21 recognizes at which position the object is arranged in storage bin 71 (S31).

Processor 21 acquires an image captured by camera 60 via communication device 24. In this captured image, the article in delivery bin 72 is reflected. Processor 21 recognizes the arrangement state of the article in delivery bin 72 based on the captured image. At this time, processor 21 recognizes a position where the object can be arranged in delivery bin 72 (S32).

Processor 21 determines an arrangement position of each of storage bin 71 and delivery bin 72 in bin arrangement region BR of picking station PS based on the arrangement state of the article in storage bin 71 and the arrangement state of the article in delivery bin 72. In this case, the arrangement position of each of storage bin 71 and delivery bin 72 in bin arrangement region BR of picking station PS may be determined based on the arrangement position of the object in storage bin 71 and the arrangeable position of the object in delivery bin 72. In this case, as an example, processor 21 may calculate the shortest arrangement that minimizes the movement distance from storage bin 71 to delivery bin 72 when the object is picked, and determine the arrangement positions of storage bin 71 and delivery bin 72 corresponding to the shortest arrangement (S33). Details of the shortest arrangement will be described later.

Processor 21 instructs, via communication device 24, conveyance robot 40C to convey storage bin 71 and delivery bin 72 into the arrangement in the determined arrangement position (S34).

Upon recognizing that storage bin 71 and delivery bin 72 are arranged in the determined arrangement positions, processor 21 instructs to perform a picking work to transfer the object from storage bin 71 to delivery bin 72 (S35). The hand of picking robot 40P may or may not return to the initial position (for example, the center position of picking robot 40P) every time the picking work is completed once.

Next, details of the shortest arrangement will be described.

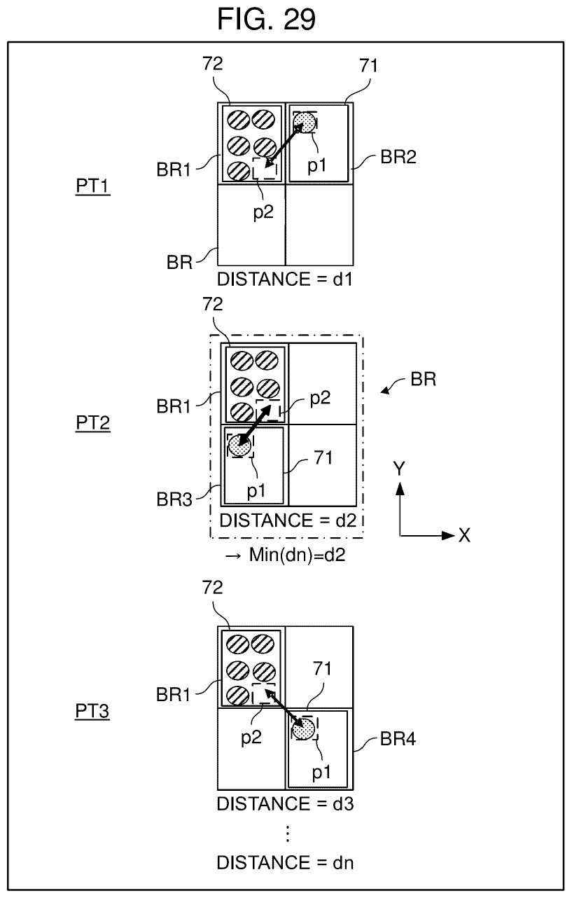

FIG. 28 is a top view of the inside of storage bin 71 and delivery bin 72. In FIG. 28, one article 85 is stored in storage bin 71, and five articles are stored in delivery bin 72. In storage bin 71 and delivery bin 72, for example, it is assumed that two articles in the X direction and three articles in the Y direction can be arranged in a planar manner (so as not to overlap each other in the vertical direction). In this case, article 85 as object 80 arranged at upper left arrangement position p1 of storage bin 71 in FIG. 28 is picked, moved to arrangeable position p2 as the lower right space of delivery bin 72, lowered to this position, and stored. As a positional relationship between storage bin 71 and delivery bin 72, for example, an arrangement pattern of FIG. 29 can be considered.

Note that arrangement position p1 may be recognized by processor 21, for example, based on a captured image obtained by imaging the inside of storage bin 71 and the object information. For example, processor 21A may determine the presence or absence of the object instructed by the picking instruction data based on various characteristics such as the size of the object, and may also determine arrangement position p1 of the object. Furthermore, arrangeable position p2 may be recognized by processor 21, for example, based on the captured image obtained by imaging the inside of delivery bin 72 and the object information. For example, processor 21A may determine arrangeable position p2 based on various features such as the arrangement state (for example, an empty space) of the article and the size of the object. For example, when an object having a predetermined size fits in an empty space in delivery bin 72, processor 21A may determine the position of the empty space as arrangeable position p2. Further, arrangement position pl and arrangeable position p2 may include a component of a position in the Z direction.

FIG. 29 is a diagram illustrating an example of an arrangement pattern in which storage bin 71 and delivery bin 72 are arranged in bin arrangement region BR. In FIG. 29, bin arrangement region BR is a rectangular region in which two bins 70 can be arranged side by side in the X direction and two bins 70 in the Y direction. Processor 21 assumes a plurality of arrangement patterns in which storage bins 71 and delivery bins 72 are arranged in bin arrangement region BR. FIG. 29 illustrates arrangement patterns PT1, PT2, and PT3.

In arrangement pattern PT1, storage bin 71 in the arrangement state of FIG. 28 is arranged in upper right region BR2 of bin arrangement region BR, and delivery bin 72 in the arrangement state of FIG. 28 is arranged in upper left region BR1 of bin arrangement region BR. In this case, the distance between arrangement position pl in storage bin 71 and arrangeable position p2 in delivery bin 72 in the XY plane is distance d1.

In arrangement pattern PT2, storage bin 71 in the arrangement state of FIG. 28 is arranged in lower left region BR3 of bin arrangement region BR, and delivery bin 72 in the arrangement state of FIG. 28 is arranged in upper left region BR1 of bin arrangement region BR. In this case, the distance between arrangement position p1 in storage bin 71 and arrangeable position p2 in delivery bin 72 in the XY plane is distance d2.

In arrangement pattern PT3, storage bin 71 in the arrangement state of FIG. 28 is arranged in lower right region BR4 of bin arrangement region BR, and delivery bin 72 in the arrangement state of FIG. 28 is arranged in upper left region BR1 of bin arrangement region BR. In this case, the distance between arrangement position p1 in storage bin 71 and arrangeable position p2 in delivery bin 72 in the XY plane is distance d3.

Among distances d1 to d3 of arrangement patterns PT1 to PT3 that can be taken by storage bin 71 with respect to delivery bin 72 in bin arrangement region BR, distance d2 is the shortest distance. Therefore, arrangement pattern PT2 in the case of distance d2 is determined as the shortest arrangement. In this manner, processor 21 calculates the shortest arrangement that minimizes the movement distance of the object in step S33.

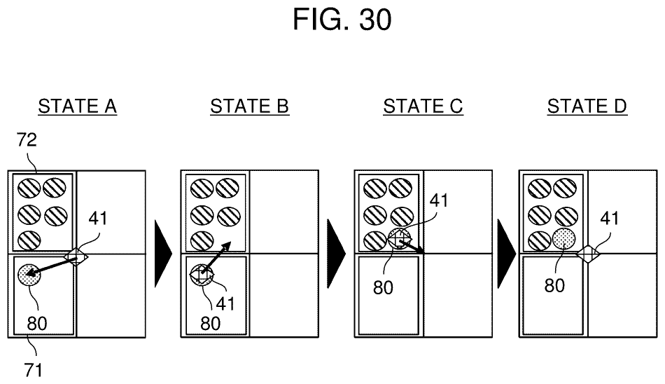

FIG. 30 is a diagram illustrating an example of a flow of movement of a hand and an object at the time of picking. In FIG. 30, it is assumed that hand 41 returns to the initial position every time the picking work is completed once.

In the picking work with arrangement pattern PT2 of FIG. 29, first, in state A, hand 41 at the initial position moves toward arrangement position p1 of object 80 in storage bin 71. Subsequently, in state B, hand 41 picks object 80. Subsequently, in state C, picked object 80 is moved to arrangeable position p2 of delivery bin 73. Subsequently, in state D, object 80 is lowered and arranged at arrangeable position p2 of delivery bin 73, and hand 41 is returned to the initial position. Therefore, in the determination of the shortest arrangement in step S33 of FIG. 27, instead of the shortest movement distance of object 80 (that is, the hand not considering the reference position), an arrangement pattern in which the movement distance of hand 41 considering the initial position at the time of the picking work is the shortest may be determined.

Hereinafter, the present exemplary embodiment will be supplemented.

In the present exemplary embodiment, warehouse management system 5A performs the arrangement control of bin 70 by utilizing at least one of the object information and the arrangement state of bin 70, that is, based on at least one of the object information and the arrangement state of bin 70. When the object information is utilized, processor 21A of host management device 20A, for example, arranges the heavy object such that the movement distance of the object or the like becomes short. Similarly, also in a case where the arrangement state of bin 70 is utilized, processor 21A arranges the heavy object such that the movement distance of the object or the like becomes short. The same applies to the case of utilizing both the object information and the arrangement state of bin 70.

Also, if there are multiple storage bins 71 in the arrangement control of bin 70, since other storage bins 71 are arranged or scheduled to be arranged at the desired arrangement positions for predetermined storage bins 71 within bin arrangement region BR, predetermined storage bins 71 may not be able to be arranged at the desired arrangement positions. The desired arrangement position is, for example, an arrangement position having the shortest takt time (time required for picking work). In this case, processor 21A may select, as the arrangement position of predetermined storage bin 71, not the optimum arrangement position but an arrangement position having a good takt time next to the optimum takt time.

In addition, when processor 21A instructs the arrangement positions of the plurality of storage bins 71 and delivery bin 72 substantially simultaneously, the processor may calculate the takt time for each of storage bins 71 and delivery bin 72. Then, processor 21A may instruct the arrangement positions of storage bin 71 and delivery bin 72 such that the takt time is shortened as a whole of a series of picking work (for example, picking work according to one shipping instruction) based on the picking instruction data.

According to warehouse management system 5A of the present exemplary embodiment, the arrangement of storage bins 71 with respect to delivery bin 72 can be optimized based on the weight of the object of the picking work designated by the picking instruction data, the size of the object, the number in bins 70, the way of putting the object into delivery bin 72, or the like. Then, by controlling the operation of picking robot 40P, warehouse management system 5A can smoothly perform the operation of the picking work (for example, picking is performed from an object located at a position as high as possible in the Z direction, and placing is performed in an empty space) when bins 70 are optimized and arranged. Therefore, warehouse management system 5A can reduce the time required for the operation of the arm, the hand, or the like of picking robot 40P as much as possible, can shorten the takt time at the time of picking work of picking robot 40P, and can speed up the picking work.

As an example, it is assumed that the picking work is performed on same delivery bin 72 from storage bin 71 arranged in region BR1 in bin arrangement region BR and storage bin 71 arranged in region BR2. In this case, since picking work from different storage bins 71 will be performed, an approach of the arms to different storage bins 71 is required,. Therefore, since the movement distance of the arm becomes long, the movement time of the arm tends to be long. In this case, storage bins 71 arranged in region BR1 may move into region BR2 without exiting from bin arrangement region BR. Processor 21 of host management device 20 may select one with a shorter required time between a case of performing the picking work while storage bin 71 or delivery bin 72 moves in bin arrangement region BR and a case of performing the picking work by causing the arm to approach different storage bin 71. Processor 21 may be able to calculate each required time by simulation.

In the present exemplary embodiment, it is exemplified that processor 21A of host management device 20A mainly executes the processing related to the bin arrangement control, but the present invention is not limited thereto. For example, processor 31A of robot control system 30A may mainly execute processing related to bin arrangement control.

### Overview of Exemplary Embodiment

As described above, at least the following matters are described in the present disclosure. Note that in parentheses, corresponding components and the like are shown in the above-described exemplary embodiments, but the present invention is not limited thereto.

### Item 1

A bin arrangement control method for controlling arrangement of a bin (bin 70) with respect to a picking robot (picking robot 40P) that performs picking work of an object (object 80), the bin including a storage bin (storage bin 71) in which the object prior to the picking work is stored and a delivery bin (delivery bin 72) in which the object after the picking work is stored, the bin arrangement control method including the steps of:
acquiring object information (object information I3) on the object;
determining a positional relationship between the storage bin and the delivery bin based on the object information; and
controlling an arrangement of the storage bin and the delivery bin with respect to the picking robot based on the determined positional relationship.

As a result, the bin arrangement control method can determine the positional relationship between the storage bin and the delivery bin in consideration of the fact that the movement time of the object may vary depending on the characteristic of the object. Therefore, the bin arrangement control method can shorten the time required for the picking work when performing the picking work of moving the object from the storage bin to the delivery bin using the picking robot.

### Item 2

The bin arrangement control method according to item 1, in which the object information includes at least one of weight information indicating a weight of the object, size information indicating a size of the object, shape information indicating a shape of the object, and material information indicating a material of the object.

As a result, the bin arrangement control method can determine the positional relationship in consideration of the fact that the movement time of the object may vary depending on the weight, size, shape, or material of the object. For example, in the bin arrangement control method, when the size of the object is small, it is difficult for the object to come into contact with another object during the picking work, and the moving speed of the hand can be increased. In addition, in the bin arrangement control method, when the size of the object is large, it is easy to come into contact with another object during picking, and the moving speed of the hand is reduced to carefully move the hand. Therefore, the bin arrangement control method can set the positional relationship in which the efficiency of the picking work of each object is improved by taking the weight and size of the object into consideration.

### Item 3

A bin arrangement control method for controlling arrangement of a bin with respect to a picking robot that performs picking work of an object, the bin including a storage bin in which the object before the picking work is stored and a delivery bin in which the object after the picking work is stored, the bin arrangement control method including the steps of:
acquiring a first image obtained by imaging the interior of the storage bin by a camera (camera 60);
acquiring a second image obtained by imaging the interior of the delivery bin by the camera;
recognizing, based on the first image, a first arrangement state that is an arrangement state of an article inside the storage bin;
recognizing, based on the second image, a second arrangement state that is an arrangement state of an article inside the delivery bin;
determining a positional relationship between the storage bin and the delivery bin, based on the first arrangement state and the second arrangement state; and
controlling an arrangement of the storage bin and the delivery bin with respect to the picking robot, based on the determined positional relationship.

As a result, the bin arrangement control method can determine the positional relationship between the storage bin and the delivery bin in consideration of the fact that the movement time of the object may vary depending on the arrangement state of the article. Therefore, the bin arrangement control method can shorten the time required for the picking work when performing the picking work of moving the object from the storage bin to the delivery bin using the picking robot. For example, when it is recognized that there are a large number of articles based on the arrangement state, the object may be arranged at a relatively shallow position in the case of the storage bin, and the object may be scheduled to be arranged at a relatively shallow position in the case of the shipping bin. This eliminates the need for the hand of the picking robot to approach a relatively deep position. In this case, the movement time of the object at the time of the picking work can be shortened. The bin arrangement control method can determine the positional relationship in consideration of this fact.

### Item 4

The bin arrangement control method according to claim 3, in which
the step of recognizing the first arrangement state includes a step of recognizing an arrangement position (arrangement position p1) of the object inside the storage bin, based on the first image and the object information,
the step of recognizing the second arrangement state includes a step of recognizing an arrangeable position (arrangeable position p2) of the object inside the delivery bin, based on the second image and the object information, and
the step of determining the positional relationship includes a step of determining the positional relationship, based on the arrangement position and the arrangeable position.

As a result, the bin arrangement control method can determine the arrangement position of the object in the storage bin and the arrangeable position of the object in the delivery bin, based on the image analysis on the first image and the second image captured by the camera and the object information. Therefore, in the bin arrangement control method, by making the arrangement position and the arrangeable position as close as possible, for example, the movement distance of the hand of the picking robot when performing the picking work of the object can be shortened, that is, the time required for the picking work can be shortened.

### Item 5

The bin arrangement control method according to item 4, in which
the arrangement position includes a position in a height direction (Z direction) inside the storage bin, and
the arrangeable position includes a position in a height direction inside the delivery bin.

The higher the position of the object in the bin, the less the movement of the hand in the height direction, so that the movement time of the object is shortened. Conversely, the lower the position of the object in the bin, the more the movement of the hand in the height direction and the longer the movement time of the object. Therefore, in the bin arrangement control method, the positional relationship between the storage bin and the delivery bin is determined in consideration of the position of the object in the height direction in the bin, so that the arrangement relationship in which the movement time of the object can be shortened can be obtained.

### Item 6

The bin arrangement control method according to item 4 or 5, in which
the step of determining the positional relationship includes the steps of:
calculating a movement distance of a hand (hand 41) of the picking robot, based on the arrangement position and the arrangeable position; and
determining a positional relationship between the storage bin and the delivery bin, based on a movement distance of the hand.

As a result, the bin arrangement control method can determine the positional relationship between the storage bin and the delivery bin, based on the movement distance of the hand equivalent to the movement distance of the object.

### Item 7

The bin arrangement control method according to item 6, in which
the step of calculating a movement distance of the hand includes
a step of calculating a movement distance of the hand, based on the arrangement position, the arrangeable position, and a reference position (initial position) of the hand.

As a result, the bin arrangement control method can derive the movement time of the object with high accuracy even when the hand moves with reference to the reference position of the hand.

### Item 8

A bin arrangement control device (host management device 20A) that includes a processor (processor 21A) and controls an arrangement of bins with respect to a picking robot that performs picking work of an object, in which
the bin includes a storage bin in which the object before the picking work is stored and a delivery bin in which the object after the picking work is stored, and
the processor
acquires object information on the object,
determines a positional relationship between the storage bin and the delivery bin, based on the object information; and
controls an arrangement of the storage bin and the delivery bin with respect to the picking robot, based on the determined positional relationship.

As a result, the bin arrangement control method can obtain the same effect as item 1.

### Item 9

A bin arrangement control device that includes a processor and controls arrangement of a bin with respect to a picking robot that performs picking work of an object, in which
the bin includes a storage bin in which the object before the picking work is stored and a delivery bin in which the object after the picking work is stored, and
the processor
acquires a first image obtained by imaging an inside of the storage bin by a camera,
acquires a second image obtained by imaging an inside of the delivery bin by a camera,
recognizes, based on the first image, a first arrangement state that is an arrangement state of an article inside the storage bin,
recognizes, based on the second image, a second arrangement state that is an arrangement state of an article inside the delivery bin,
determines a positional relationship between the storage bin and the delivery bin, based on the first arrangement state and the second arrangement state, and
controls an arrangement of the storage bin and the delivery bin with respect to the picking robot, based on the determined positional relationship.

As a result, the bin arrangement control method can obtain the same effect as item 3.

Although various exemplary embodiments have been described above with reference to the drawings, it goes without saying that the present disclosure is not limited to such examples. It is obvious that those skilled in the art can conceive various changes or modifications within the scope described in the claims, and it is understood that those changes or modifications naturally belong to the technical scope of the present disclosure. In addition, the components in the above exemplary embodiments may be arbitrarily combined without departing from the gist of the invention.

In addition, in the above exemplary embodiments, a program that implements the function of the bin arrangement control method may be supplied to a computer (for example, host management device 20) via a network or various storage media, and a program read and executed by a processor of the computer and a recording medium in which the program is stored may also be an application range.

### INDUSTRIAL APPLICABILITY

The present disclosure is useful for a bin arrangement control method, a bin arrangement control device, and the like that can shorten a time required for picking work when picking work of moving an article from a storage bin to a delivery bin is performed using a picking robot.

### REFERENCE MARKS IN THE DRAWINGS

5: warehouse management system
10: warehouse management device
20, 20A: host management device
21, 21A: processor
22: memory
23: input device
24: communication device
25: input and output interface
30, 30A: robot control system
31, 31A: processor
32: memory
33: input device
34: communication device
35: input and output interface
40: robot device
40C: conveyance robot
40P: picking robot
41: hand
45: worker
50: warehouse
60: camera
70: bin
71: storage bin
72: delivery bin
80: object
85: article
BR: bin arrangement region
PS: picking station
p1: arrangement position
p2: arrangeable position

1. A bin arrangement control method for controlling arrangement of a bin with respect to a picking robot that performs picking work of an object, the bin including a storage bin in which the object prior to the picking work is stored and a delivery bin in which the object after the picking work is stored, the bin arrangement control method comprising:
acquiring object information on the object;
determining a positional relationship between the storage bin and the delivery bin based on the object information; and
controlling an arrangement of the storage bin and the delivery bin with respect to the picking robot based on the determined positional relationship.

2. The bin arrangement control method according to claim 1, wherein the object information includes at least one of weight information indicating a weight of the object, size information indicating a size of the object, shape information indicating a shape of the object, and material information indicating a material of the object.

3. A bin arrangement control method for controlling arrangement of a bin with respect to a picking robot that performs picking work of an object, the bin including a storage bin in which the object before the picking work is stored and a delivery bin in which the object after the picking work is stored, the bin arrangement control method comprising:
acquiring a first image obtained by imaging an interior of the storage bin by a camera;
acquiring a second image obtained by imaging an interior of the delivery bin by the camera;
recognizing, based on the first image, a first arrangement state that is an arrangement state of an article inside the storage bin;
recognizing, based on the second image, a second arrangement state that is an arrangement state of an article inside the delivery bin;
determining a positional relationship between the storage bin and the delivery bin, based on the first arrangement state and the second arrangement state; and
controlling an arrangement of the storage bin and the delivery bin with respect to the picking robot, based on the determined positional relationship.

4. The bin arrangement control method according to claim 3, further comprising acquiring object information on the object, wherein
the recognizing of the first arrangement state includes recognizing an arrangement position of the object inside the storage bin, based on the first image and the object information,
the recognizing of the second arrangement state includes recognizing an arrangeable position of the object inside the delivery bin, based on the second image and the object information, and
the determining of the positional relationship includes determining the positional relationship, based on the arrangement position and the arrangeable position.

5. The bin arrangement control method according to claim 4, wherein
the arrangement position includes a position in a height direction inside the storage bin, and
the arrangeable position includes a position in a height direction inside the delivery bin.

6. The bin arrangement control method according to claim 4, wherein
the determining of the positional relationship includes:
calculating a movement distance of a hand of the picking robot, based on the arrangement position and the arrangeable position; and
determining the positional relationship based on a movement distance of the hand.

7. The bin arrangement control method according to claim 6, wherein
the calculating of the movement distance of the hand includes
calculating a movement distance of the hand, based on the arrangement position, the arrangeable position, and a reference position of the hand.

8. A bin arrangement control device that includes a processor and controls arrangement of a bin with respect to a picking robot that performs picking work of an object, wherein
the bin includes a storage bin in which the object before the picking work is stored and a delivery bin in which the object after the picking work is stored, and
the processor
acquires object information on the object,
determines a positional relationship between the storage bin and the delivery bin, based on the object information, and
controls an arrangement of the storage bin and the delivery bin with respect to the picking robot, based on the determined positional relationship.

9. A bin arrangement control device that includes a processor and controls arrangement of a bin with respect to a picking robot that performs picking work of an object, wherein
the bin includes a storage bin in which the object before the picking work is stored and a delivery bin in which the object after the picking work is stored, and
the processor
acquires a first image obtained by imaging an inside of the storage bin by a camera;
acquires a second image obtained by imaging an inside of the delivery bin by the camera;
recognizes, based on the first image, a first arrangement state that is an arrangement state of an article inside the storage bin;
recognizes, based on the second image, a second arrangement state that is an arrangement state of an article inside the delivery bin;
determines a positional relationship between the storage bin and the delivery bin, based on the first arrangement state and the second arrangement state; and
controls an arrangement of the storage bin and the delivery bin with respect to the picking robot, based on the determined positional relationship.
